(19) United States
(12) Patent Application Publication
(10) Pub. No.: US 2007/0042791 A1
(43) Pub. Date: Feb. 22, 2007

(54) Presence and availability management over a public communication network

(75) Inventor: Edward Walter, Boerne, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/205,293

(22) Filed: Aug. 16, 2005

(51) Int. Cl. H04M 3/42; H04Q 7/20

(52) U.S. Cl. 455/461; 379/211.01; 379/211.02

(57) ABSTRACT

A system and method are disclosed for providing a distributed presence and availability management network (PAMN). PAMN presence detection elements or devices can be distributed throughout enterprise, wireless, and wire-line communication systems. The PAMN can include a first element having a first session initiated protocol (SIP) application to interface to an enterprise platform and collect enterprise system based presence information. The PAMN can also include a second element having a second SIP application to interface to a public wire-line communication network and collect public wire-line network based presence information. The PAMN can further include a third element having a third SIP application to interface to a wireless communication network and collect public wireless network based on public wireless communication presence information. In a particular embodiment, a presence and availability clearinghouse can receive the enterprise system based presence information via the first SIP interface, the public wire-line network based presence information via the second SIP interface and the public wireless network based presence information via the third SIP interface.

### FIELD OF THE DISCLOSURE

The present disclosure relates generally to communication systems and more particularly to detecting the presence and availability of a target party over communication networks.

### BACKGROUND

Presence and availability management system are systems that can gather information regarding a party's availability and utilize such information to contact the party. The term “find me” in the telecommunication arts originates from systems where a caller dials a single telephone number and the service provider consults a call list for additional target party telephone numbers and attempts to contact the target party utilizing additional numbers stored in the call list. The term “follow me” originates from a call forwarding service that can sequentially forward calls when a communication device cannot make contact with a target party. Presence and availability management systems differ from find me follow me systems in that presence and availability systems can utilize historical information to determine where to send a communication request. Certain presence and availability management systems are limited in the quality of information they can acquire due to many factors. Accordingly, a presence management system that provides improved presence and availability information would be desirable.

### BRIEF DESCRIPTION OF THE DRAWINGS

FIG. 1 is a block diagram of an exemplary presence management system;

FIG. 2 is a block diagram of a simplified presence management network;

FIG. 3 is a block diagram of voice communication network;

FIG. 4 is a flow diagram for a method for implementing a presence management system; and

FIG. 5 is a general diagram representative of an embodiment of a general computer system.

### DETAILED DESCRIPTION OF THE DRAWINGS

A system and method for providing a distributed presence and availability management network (PAMN) is disclosed. The PAMN can include a first element having a first session initiated protocol (SIP) application to interface an enterprise platform and collect enterprise system based presence information. The PAMN can also include a second element having a second SIP application to interface a public wire-line communication network and collect public wire-line network based presence information. The PAMN can further include a third element having a third SIP application to interface a wireless communication network and collect public wireless network based on public wireless communication presence information.

In a particular embodiment a presence and availability clearinghouse can receive the enterprise system based presence information via the first SIP interface, the public wire-line network based presence information via the second SIP interface and the public wireless network based presence information via the third SIP interface. The presence and availability management clearinghouse can provide presence and availability information to a find me follow me system improving the probability that the find me follow me system can locate the target party.

PAMN presence detection elements or devices can be distributed throughout the public and private communication networks. For example a private enterprise network, a public wireless network and public wire-line communication network. The presence and availability management clearinghouse can provide multiple target party device addresses and target party availability data for the multiple devices including a wireless device, a wire-line device, and a computing device running desktop applications. The computing device and its application can be part of an enterprise system or it can be a single personal computer that utilizes a wire-line type connection such as an Internet connection.

In one configuration the enterprise system based presence information can provide information from a desktop application, a calendar application, an e-mail application, a voice over Internet protocol application, or a messaging application. The public and private network based elements can acquire presence information via a fiber optic system, a passive optical network, a public switched telephone network (PSTN), a plain old telephone system (POTS), an Ethernet based system, an Internet protocol system, a voice over Internet protocol (VoIP) system, a digital subscriber line (DSL) line configuration or a T1 line configuration.

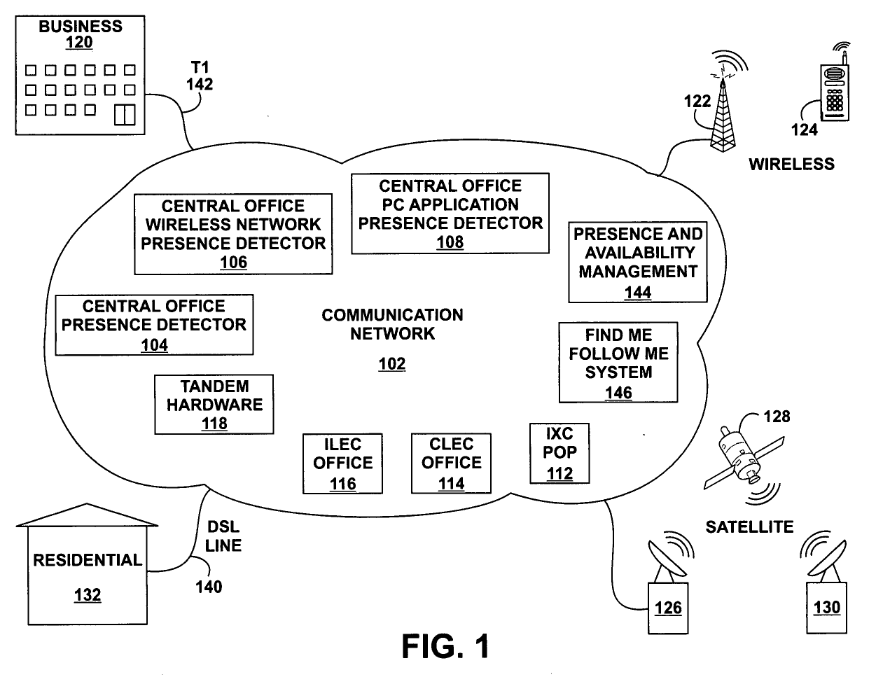

Referring to FIG. 1 an exemplary communication system including a communication network 102 that supports communication services to a business 120, a residence 132, a wireless subscriber 124 via tower antenna 122, and a satellite subscriber 130 via dish antennae 126 and a satellite 128 is shown. The business 120 may receive communications via a T1 line 142, and the residence may receive communications via a digital subscriber line 140. Alternate connections such as fiber optic lines, a public switched telephone network (PSTN), a plain old telephone system (POTS), an Ethernet based system, an Internet protocol (IP) system, or an Internet voice system could also be utilized.

The communication network 102 can be a wide area network and can have multiple facilities and communication elements for routing data, tracking call data and acquiring presence and availability information. Facilities and communication elements that support the illustrated communication network include a central office, with a wire-line presence detector 104, tandem office with presence hardware elements 118, an incumbent local exchange carrier, (ILEC) facility 116, a competitive local exchange carrier (CLEC) facility 114, an interexchange carrier (IXC) point of presence (POP) facility 112, a central office with a presence detector elements for enterprise or desktop applications 108, and a central office with wireless network presence detector elements 106. Additionally, the communication network can include a presence and availability management clearinghouse (PAMC) 144 and a find me follow me system 146.

Different communication components and presence management elements are illustrated at various offices or facilities. However, any system, such as PAMC 144 and the find me follow me system 146 could be present at any type of office or facility. Additionally, PAMC 144, the find me follow me system 146, and the presence detection elements could be located at the business 120, near the residence 132 and at the wireless facility such as near the tower antennae 122 and the dish antennae 126.

In a particular embodiment, presence detector elements such as the central office wire-line network presence detector 104, the central office wireless network presence detector 106, and the central office enterprise or desktop application presence detector 108 can detect target party device usage or device transmissions over the communication network 102. Based on the detected presence information, the elements can provide presence and availability information utilizing a session initiated protocol (SIP) control format to send communication to the PAMC 144 over the communication network 102. The find me follow me system 146 can access the PAMC 144 and utilize the presence and availability information acquired by the PAMC 144 to route, forward, or re-address a call or take a message, increasing the chances of contacting a target party.

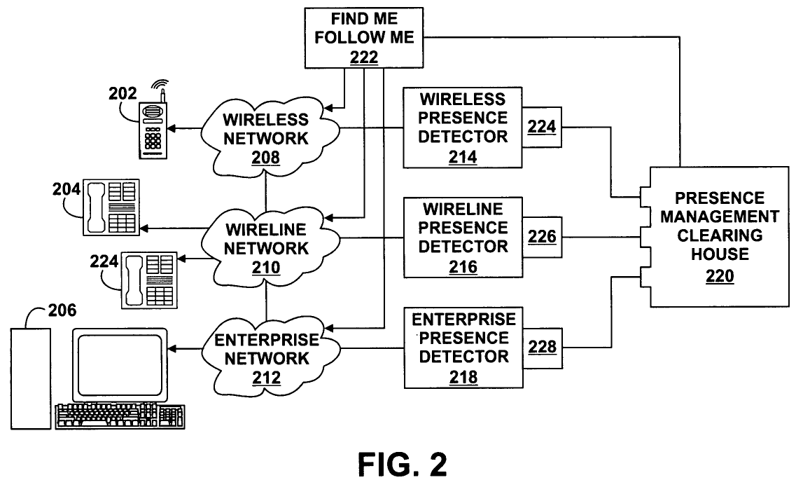

FIG. 2 is an exemplary embodiment of a system that can integrate presence and availability information acquired from presence detection elements that reside on different communication systems at various locations. The presence detection elements can in turn provide presence and availability information to a find me follow me system via a presence management network. Radiotelephone 202 can communicate with other communication devices such as a first wire-line telephone 204, a second wire-line telephone 224, and a computer terminal 206 via wireless network 208, wire-line network 210, and enterprise network 212. Computer terminal 206 could be a personal computer, an enterprise class terminal, or a workstation. The computer terminal 206 could run enterprise applications, applications that communicate over a local area network, and applications that exchange data with mainframe computers or service providers over a wire-line connection, such as the Internet.

A wireless network presence detector element 214 can be coupled to the wireless network 208. A wire-line network presence detector element 216 can be coupled to the wire-line communication system 210, and an enterprise communication network presence detector element 218 can be coupled to the enterprise network 212. The enterprise network 212 can facilitate communications between users of desktop applications, such as calendars, e-mail and other applications wherein user activity can be detected and personal or business calendars or schedules can be accessed by the enterprise presence detector 218.

Enterprise class exchange provisions, live communications servers (LCS) and desktop tools such as Outlook® and “Chat” can all provide presence and availability information via a communications network. Personal desktop applications operating on computer terminal 206 or on a personal digital assistant as part of the radiotelephone 202 can also be monitored or accessed by the wireless network presence detection element 214 and the wire-line network presence detection element 216.

The presence detection elements can be installed at business facilities, on main communication trunk lines, trunk line junctions or entry and exit points to main communication trunks. These locations may be at a central office, a tandem office an ILEC, a CLEC an IXC location or at any location on a public communication network.

Presence detectors 214, 216 and 218 can acquire presence information by passively listening to communication signals transmitted and received by communication devices such as radiotelephone 202, first wire-line phone 204, second wire-line phone 224, and computer terminal 206. Presence and availability information can be determined based on recognition of a communication device identifier that is typically transmitted as part of a communication. The communication device identifier may be an IP address, a MAC address, a private IP address, a user name, or a radiotelephone identification number.

The presence detectors can store a list of communication device identifiers and monitor communications for the devices in the list. When a specific communication device identifier is determined, presence information can be acquired from such a transmission over the public communication network or a private communication network. The acquired data can include timestamp and location information such that the time and place of the communication event can be determined at a different time and place.

The wireless presence detector 214 can have a wireless SIP interface 224 or application for converting data and sending data in a SIP format to a presence management clearinghouse 220. Likewise wire-line presence detector 216 can have a wire-line SIP interface 226 and enterprise presence detector 218 can have an enterprise SIP interface 228 to convert presence signals into a SIP format and transmit such signals to the presence management clearinghouse 220.

In a particular embodiment the presence management clearinghouse 220 can sort data in a relational database by an entry such as target party, time of occurrence, place of occurrence, device identifier, and many other variables. The presence management clearinghouse 220 can request information from the presence detectors 214, 216, and 218 and receive transmissions from the presence detectors 214, 216, and 218. The presence and availability information can include communication device usage information, scheduling information and statistical device usage trends. The communication between the networks 208, 210 and 212 and the detectors 214, 216 and 218 can also utilize a SIP format.

In a particular embodiment the presence management clearinghouse 220 receives and processes specific requests from the find me follow me system 222. The specific requests may contain a format and identity data that requests specific information for a specific target party or target device. Alternately, the presence management clearinghouse 220 can send status updates to the find me follow me service system 222 when available, and the find me follow me system 222 can provide a find me follow me service to callers, subscribers and target parties. In the present disclosure the term “caller” can be understood as a person that places a call, hence a caller does not have to be a subscriber to a presence management or find me follow me service.

The find me follow me system 222 can store a contact list and presence and availability information for a target party and utilize such information to route, forward, or re-address calls and take messages. The contact list can contain a list of telephone numbers, e-mail addresses, Internet protocol (IP) addresses, and other contact information for a target party. A probability can be assigned to entries in the call list based on the presence and availability information. The probability assigned to a contact address can indicate that utilizing a specific contact address with a higher probability value has a better probability of contacting the target party than a contact address with a lower assigned probability. The assigned probabilities can be utilized to select numbers form the call list responsive to an incoming call. The find me follow me system 222 can also forward incoming calls to a target party based on presence and availability information from the presence management clearinghouse 220 and the find me follow me system 222 can provide a message back to the caller that the call is being transferred to an alternate device based on presence information.

In operation, a target party may be associated with the first wire-line phone 204, the radiotelephone 202, and the computer terminal 206 utilizing a target party identifier and a call list in a database. Current or past usage of target party devices or information from a target party schedule can be determined and stored by the presence management clearinghouse 220. A caller may initially dial a telephone number on the second wire-line phone 224 attempting to contact the target party on the first wire-line phone 204. The find me follow me system 222 may access presence and availability information and based on the information, direct a request for the first wire-line phone 204 or to the radiotelephone 202 via wireless network 208.

In a particular embodiment, the presence detectors 214, 216, and 218 can send a ping request (i.e. request for presence information) to the communication devices 202, 204, 224 and 206. The communication devices 214, 216, and 218 can send a reply to the presence detectors 214, 216 and 218 and the presence detectors 214, 216 and 218 can send presence and availability information to the presence management clearinghouse 220.

The word “ping” has its origin from the term “Packet Internet Groper” and the word ping as it is utilized herein, should not be strictly construed but should be given a broader definition such as a request for information. A ping command can be utilized to determine a schedule, retrieve a status, retrieve historical usage, and determine an availability of target device or a target party.

In one embodiment as radiotelephone 202 moves into a zone where radio contact is poor or non-existent and the radiotelephone 202 loses communication, the wireless network presence detector 214 and the find me follow me engine 222 can track this phenomena and tag the party's availability status as “unavailable” for communication. When it is determined that the party is unavailable, the communication can be rerouted to another communication device such as to a central voice mail location or an e-mail server (possibly accessible by computer terminal 206).

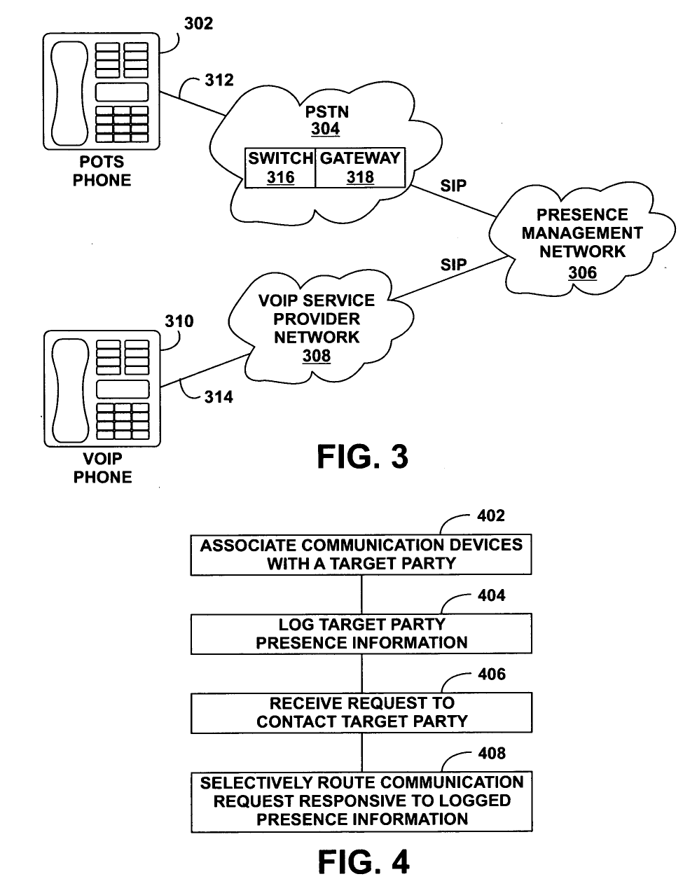

Referring to FIG. 3, a partial presence management system for a wire-line system that integrates a voice over Internet protocol (VoIP) and a time division multiplexing (TDM) environment is illustrated. In a particular embodiment, a carrier of communication services can provide presence management and find me follow me services to both consumers and businesses. A plain old telephone system (POTS) type phone 302 can be connected to a public switched network (PTSN) 304 via time division multiplexing (TDM) connection 312 and a VoIP phone 310 can be connected to a VoIP service provider 308 via digital communication line 314. The VoIP service provider 308 and the PSTN 304 can be coupled to a presence management network 306. A switch 316, such as a class 5 switch, can route or switch calls according to the addressing information associated with a call request.

In operation, the POTS phone user can place a call across the TDM line 312 and the call can be switched by switch 316. Data acquired from activities associated with the switch 316 can provide presence information to the presence management network 306. Presence information may include an indicator that a particular party is on the phone, that a party has recently hung up or that a party has set a phone to a do-not-disturb configuration.

Many configurations could be utilized to provide connectivity between the PSTN 304 and the presence management network 306. One such configuration can leverage primary rate interfaces (PRI's) and convert the analog signals of the PSTN to IP signals via a gateway 318. In another configuration the switch 316 can be “back-ended” with an IP gateway 318 that converts data transmissions from the switch 316 into an Internet protocol (IP) protocol format such as a SIP format. The presence management network 306 can leverage the SIP format to determine if the party is using a phone or other presence and availability information as described in reference to FIG. 2.

In another embodiment, a target party can be called over a carrier based VoIP phone 310. In this embodiment the phone signals can be IP based. A party on a VoIP phone 310 can utilize VoIP service provider network 308 and the call can be switched via the components of the VoIP system. The SIP signaling format can be sent to the presence management network 306 and presence and availability information can be stored. The IP based format can provide an efficient method for signaling presence and availability information between the VoIP network 308 and the presence management network 306.

A cellular carrier could also provide a conversion from a cellular format such as a code division multiple access, (CDMA) or a time division multiple access (TDMA) system to SIP format and send the SIP messages to the presence management server 306.

Referring to FIG. 4, a flow diagram of an exemplary method for presence management is provided. At block 402 communication devices are associated with a target party. The communication devices can take many forms such as a radiotelephone, a personal digital assistant, a landline telephone or wire-line telephone such as a VoIP phone and personal computer that can run desktop applications. At block 404, communications over various networks are monitored and data can be actively requested from presence detection elements and devices. Based on these communications, presence information is acquired and logged. In a particular embodiment the presence information is passively determined, requested, and received utilizing a SIP format.

At block 406, a request to route a call or contact a target party is received and the call is selectively routed, at block 408, in accordance with the presence and availability information and rules utilized by a find me follow me system.

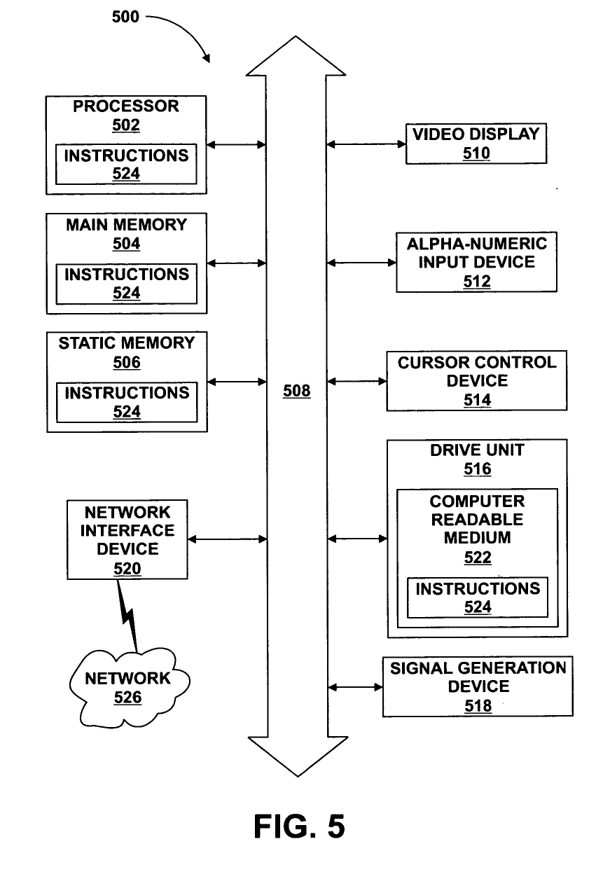

Referring to FIG. 5, an illustrative embodiment of a general computer system is shown and is designated 500. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics-processing unit (GPU), or both. Moreover, the computer system 500 can include a main memory 504 and a static memory 506 that can communicate with each other via a bus 508. As shown, the computer system 500 may further include a video display unit 510, such as a liquid crystal display (LCD), an organic light emitting diode (OLED), a flat panel display, a solid-state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video, or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A network based presence management communication system comprising:
a first element including a first session initiated protocol (SIP) application to interface to an enterprise platform and collect enterprise system based presence information;
a second element including a second SIP application to interface to a public wire-line communication network and collect public wire-line network based presence information;
a third element including a third SIP application to interface to a wireless communication network and collect public wireless network based public presence information; and
a presence management clearinghouse having a presence management database configured to receive the enterprise system based presence information via the first SIP application, the public wire-line network based presence information via the second SIP application and the public wireless network based presence information via the third SIP application, wherein the enterprise system based presence information, the public wireline network based presence information and the public wireless network based presence information can be provided to a find me follow me system to assist in contacting a target party.

2. The system as in claim 1, wherein presence management database is a relational database that stores presence information including at least one of a target party device or a target party availability for one of a wireless device, a wire-line device, and a computing device.

3. The system as in claim 1, wherein the enterprise platform acquires presence information from at least one of a desktop application, a calendar application, a scheduling application, an e-mail application, a voice over Internet protocol application, or a messaging application.

4. The system as in claim 1, wherein the public wire-line network presence information is acquired via a fiber optic system, a passive optical network, a public switched telephone network (PSTN), a plain old telephone system (POTS), an Ethernet system, an Internet protocol system, a voice over Internet protocol (VoIP) system, a digital subscriber line (DSL) system, or a T1 line configuration.

5. The system as in claim 1, wherein the presence management clearinghouse communicates with one of the first element, the second element, or the third element before transmitting presence information to the find me follow me system.

6. The system as in claim 1, wherein the find me follow me system further includes a call list providing at least two contact addresses where a target party can be reached.

7. The system as in claim 1, wherein the find me follow me system can forward a communication request to a radiotelephone, a wire-line telephone, an Internet protocol based phone, a personal computer, a paging device, and a personal digital assistant.

8. The system as in claim 1, wherein the find me follow me system can forward a communication request based on a connection probability determined based on presence and availability information.

9. A method of contacting a target party, the method comprising:
associating a first communication device with a target party and associating a second communication device with the target party, the first and second communication devices configured to communicate via a public communication network;
logging presence information of the target party, the presence information including location and availability data with respect to the first communication device and the second communication device, the logging responsive to receipt of communication control signals utilized by the first communication device and the second communication device in communications over one of a public wire-line communication network, a public wireless network, or an enterprise network; and
receiving a communication request to contact the target party and selectively routing the communication request to the first communication device or the second communication device based on the logged presence information.

10. The method of claim 9, wherein when the target party is not available via the first communication device, the communication request is routed to the second communication device responsive to the logged presence information.

11. The method of claim 9, further comprising notifying an originator of a call that an alternate communication device has been selected by a call routing system.

12. The method of claim 9, wherein the presence information is determined based on one of a communication activity of the target party or a ping to a target party device, wherein the presence information is one of a device status originating from a communication device transmission, a status request, or a passive data acquisition from a device-to-device communication.

13. The method of claim 9, wherein presence information is determined based on detecting one of a communication device identifier, an IP address, a MAC address, a private IP address, a user name, and a radiotelephone identification number.

14. The method of claim 13, further comprising storing a list of communication device identifiers and monitoring communication traffic for presence information related to the communication device identifiers at a presence detection element coupled to a public communication network.

15. The method of claim 9, further comprising storing presence information at central offices and communicating presence information between the central offices and a presence management clearinghouse.

16. The method of claim 9, further comprising assigning a first probability that a target party will be contacted via a first device identifier, assigning a second probability that the target party will be contacted via a second device identifier, and utilizing the first and second probability to selectively route the communication request.

17. The method of claim 9, wherein target party presence information is acquired via Internet protocol based control signals.

18. The method of claim 9, further comprising monitoring communication addresses over one of a communication trunk line, a communication backbone, or a communication line junction, and logging a communication device address and sending a time and place stamped communication address to a presence management clearinghouse.

19. A computer readable medium tangibly embodying a program of instructions to manipulate a processor to:
associate a first communication device with a target party and associate a second communication device with the target party, the first and second communication devices configured to communicate via a public communication network;
log presence information of the target party based on the receipt of communication control signals utilized by the first device and the second device to communicate over the public communication network; and
receive a communication request to contact the target party and selectively routing the communication request to the first communication device or the second communication device based on the logged presence information.

20. The computer readable medium as in claim 19, further comprising forwarding the call to an alternate number when a target party is not available via the first communication device.
